(19) United States
(12) Patent Application Publication
(10) Pub. No.: US 2009/0056042 A1
(43) Pub. Date: Mar. 5, 2009

(54) CLEANING TOOL

(76) Inventor: Daniel Pena, Tucson, AZ (US)

Correspondence Address: SCHMEISER OLSEN & WATTS, 18 E UNIVERSITY DRIVE, SUITE # 101, MESA, AZ, 85201, US

(21) Appl. No.: 12/203,067

(22) Filed: Sep. 2, 2008

Related U.S. Application Data
(60) Provisional application No. 60/968,997, filed on Aug. 30, 2007.

(51) Int. Cl. B08B 7/00

(52) U.S. Cl. 15/3

(57) ABSTRACT

A cleaning tool, which includes a power unit having a gas powered engine with a carburetor and fuel servo, and a nozzle unit operatively coupled with the power unit, the nozzle unit including a throttle controller. The gas cleaning tool includes a control circuit which adjusts the amount of fuel flowing through the carburetor in response to a wireless signal provided in response to adjusting the throttle controller. The gas control circuit includes a microcontroller in communication with the throttle controller and fuel servo, the microcontroller being hermetically sealed within a housing of the power unit.

### CROSS-REFERENCE TO RELATED APPLICATIONS

This patent application claims priority to U.S. Provisional Application No. 60/968,997 filed on Aug. 30, 2007, by the same inventor, the contents of which are incorporated herein by reference.

### BACKGROUND OF THE INVENTION

1. Field of the Invention

This invention relates generally to motorized tools for cleaning.

2. Description of the Related Art

It is often desirable to be able to clean a surface which is either submerged or very close to the surface of a body of water. For example, it is often desirable to remove mineral deposits from the tiles of a pool. Cleaning pool tiles is often accomplished by scrubbing them with a hand-held scrubbing brush. However, this task is very labor and time intensive. There are various tools available which decrease the amount of labor and time required to clean surfaces, such as pool tiles. For example, U.S. Pat. Nos. 4,463,525, 6,502,269, 6,842,931, as well as U.S. Patent Application No. 2006/0156497, the contents of all of which are incorporated herein by reference. Other tools which can be used for cleaning are disclosed in U.S. Pat. Nos. 2,804,673, 4,202,067 and 6,412,136, the contents of all of which are incorporated herein by reference. Some of these tools are not designed to operate near water, and others provide a limited amount of power for cleaning. Thus, there is a need for a tool which can clean a surface which is submerged or very close to the surface of a body of water, wherein the tool provides more power.

### BRIEF SUMMARY OF THE INVENTION

The present invention provides a cleaning tool, which includes a power unit having a gas powered engine with a carburetor servo or current sensor, a nozzle unit operatively coupled with the power unit, the nozzle unit including a throttle or voltage controller. The cleaning tool includes a control circuit which adjusts the amount of fuel flowing through the carburetor in response to a wireless signal provided in response to adjusting the throttle controller.

The present invention provides a cleaning tool, which includes a power unit having a gas powered engine with a carburetor and fuel servo, and a nozzle unit operatively coupled with the power unit, the nozzle unit including a throttle controller. The cleaning tool includes a control circuit which adjusts the amount of fuel flowing through the carburetor in response to a wireless signal provided in response to adjusting the throttle controller. The control circuit includes a microcontroller in communication with the throttle controller and fuel servo, the microcontroller being hermetically sealed within a housing of the power unit.

Further features and advantages of the invention will be apparent to those skilled in the art from the following detailed description, taken together with the accompanying drawings.

### BRIEF DESCRIPTION OF THE DRAWINGS

FIGS. 1 and 2 are perspective views of a cleaning tool, in accordance with the invention.

FIG. 2 is a close-up side view of the cleaning tool of FIG. 1 showing the retaining ring.

FIG. 3 is a side view of the cleaning tool of FIGS. 1 and 2.

FIG. 4 is a close-up view of a nozzle control handle include with the cleaning tool of FIGS. 1 and 2.

FIG. 5 is a schematic diagram of a control circuit included with the cleaning tool of FIGS. 1 and 2.

FIGS. 6a, 6b, 6c and 6d are schematic diagrams of a control circuit included with the cleaning tool of FIGS. 1 and 2.

### DETAILED DESCRIPTION OF THE INVENTION

The invention employs a cleaning tool 100 which can be used to remove undesirable material from a working surface. The working surface can be a surface of many different type of structures, such as a swimming pool tile. The undesirable material can be of many different types, such as calcium and alkaline material, which often forms on swimming pool tiles. The undesirable material is often referred to as scum and grime.

It should be noted, however, that cleaning tool 100 can be used to remove undesirable material from other structures, such as scuff paint and rust from a vehicle. Cleaning tool 100 can also be used to remove grout, resins, paint epoxies, etc. It also grinds concretes and metal and smoothes imperfections around rocks, cracks and chipped surfaces. It is sometimes desirable to smooth an imperfection in the structure so it can be filled with a filling material, such as grout and paint.

Cleaning tool 100 is light-weight and portable, so it can be easily carried by a user. Cleaning tool 100 can be carried in many different ways, because it is compact and has a light weight. For example, it can be carried like a back pack while in use.

One or more portions of cleaning tool 100 are hermetically sealed so that it can be exposed to moisture with a reduced likelihood of failing. For example, the working surface of the structure is sometimes wet or submerged in water. Hence, it is desirable to be able to submerge cleaning tool 100, or a portion thereof, in water in order to remove the undesirable material from the working surface.

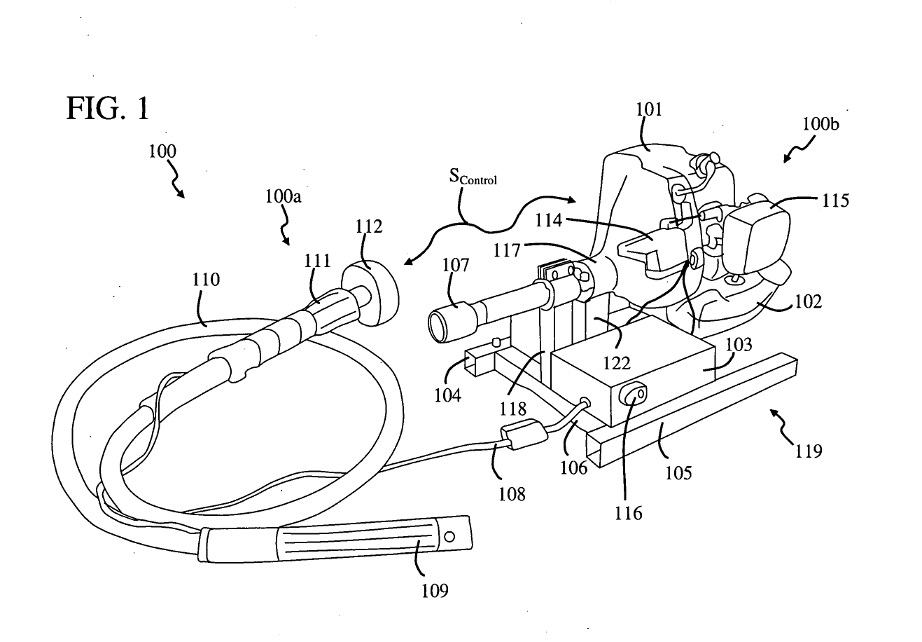

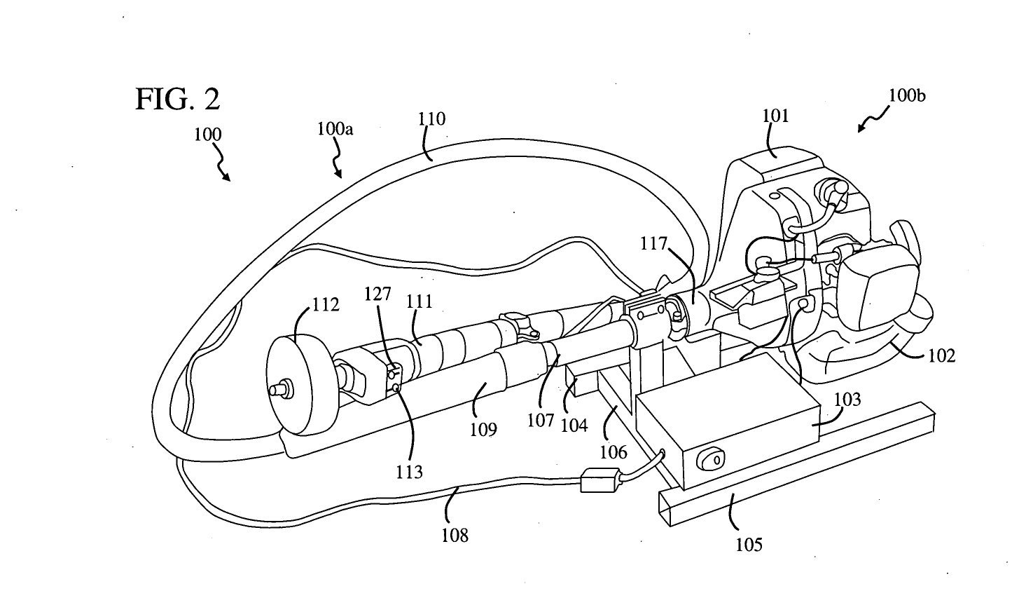

In this embodiment, cleaning tool 100 includes a nozzle unit 100a and a power unit 100b operatively coupled together (FIG. 1). Nozzle and power units 100a and 100b are repeatably moveable between positions uncoupled from and coupled to each other, as shown in FIGS. 1 and 2, respectively. Power unit 100b provides power to nozzle unit 100a and nozzle unit 100a is used to remove the undesirable material from the working surface.

In accordance with the invention, nozzle unit 100a, or a portion thereof, is hermetically sealed so it can operate while exposed to moisture, such as when it is submerged under water. For example, nozzle unit 100a can operate while submerged in swimming pool water in order to remove calcium material from a pool tile. In this way, cleaning tool 100 can be used above or below a swimming pool water surface.

In this embodiment, nozzle unit 100a is carried with one hand of the user and power unit 100b is carried with his or her other hand. The hand that carries nozzle unit 100a is referred to as the working hand and the hand that carries power unit 100b is referred to as the carrying hand. Nozzle unit 100a can be operated with the working hand while power unit 100b is being carried with the carrying hand. In this way, cleaning tool 100 is operated and carried with separate hands of the user.

In some situations, however, nozzle unit 100a is operated by the user with his or her working hand and power unit 100b is supported on a support surface, such as a pool deck, so it is not carried with the person's carrying hand while nozzle unit 100a is being operated.

In other situations, nozzle unit 100a is operated by the user with his or her working hand and power unit 100b is supported on his or her back. Power unit 100b can be carried on the person's back in many different ways, such as like a backpack.

In this embodiment, power unit 100b includes a support structure 119 which supports the components included therein. Here, support structure 119 includes support beams 104 and 105 coupled together with a cross-plate 106. Support beams 104 and 105 operate as support legs so that power unit 100b can be positioned on a support surface, such as the pool deck mentioned above. A support arm 118 extends upwardly from cross-plate 106 and is used to support components of power unit 100b, as will be discussed in more detail presently.

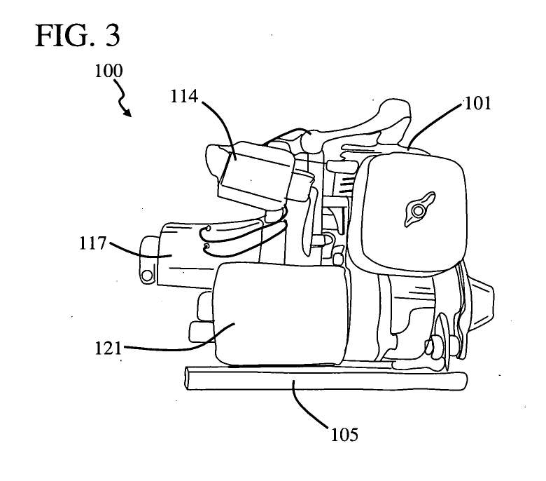

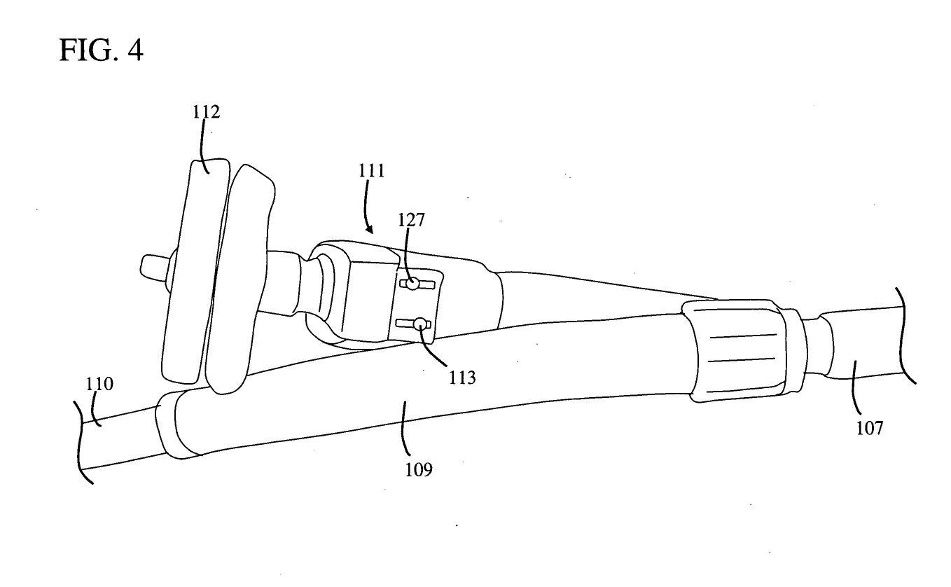

Power unit 100b can include many different components that operate to provide power to nozzle unit 100a. In this embodiment, power unit 100b includes a battery 122 operatively coupled with an engine starter 121 (FIG. 3). In this embodiment, battery 122 is an 18 volt electrical battery and engine starter 121 is a 12 volt engine starter. It should be noted, however, that battery 122 and engine starter 121 can provide many other voltages. Battery 122 provides power to engine starter 121 and, in response, engine starter 121 starts an engine 101.

In this embodiment, engine 101 is a gas engine, such as a 30.5 cubic centimeter gas engine. However, engine 101 can be of many other different sizes. Further, engine 101 can be of many different types, such as an electrical motor which is battery operated. In the electrical motor embodiments, cleaning tool 100 may or may not include a power cord which can be connected to a power source, such as an electrical outlet, to provide power to the electrical motor and/or battery. In this way, the battery can be charged. In other embodiments, the battery can be removed from power unit 100b and charged. In still other embodiments, the battery is charged while in power unit 100b by using electromagnetic charging. An example of electromagnetic charging is disclosed in U.S. Pat. Nos. 6,803,744, 6,906,495 and 7,248,017, the contents of which are incorporated herein by reference. Electromagnetic charging is often referred to as induction power transfer. In this way, power unit 100b can remain hermetically sealed while the battery is being charged. The electrical outlet can be at many different locations, such as the pool's filtration system.

In this embodiment, engine 101 is operatively coupled with a carburetor 115 and a fuel tank 102. A fuel servo 114 is operatively coupled to carburetor 115 and controls the flow of fuel between engine 101 and fuel tank 102. Fuel servo 114 is controlled by a control circuit 120 that receives a control signal S_{Control} from a throttle controller 113 included with nozzle unit 100a. Throttle controller 113 can be of many different types, but, in this embodiment, it is a gas engine throttle magnetic sensor. The advantage of having a magnetic throttle sensor is reliability and cost. Further, a magnetic throttle sensor performs better, has better quality, and lasts longer. In response to control signal S_{Control} from throttle controller 113, fuel servo 114 adjusts the amount of fuel flowed between engine 101 and fuel tank 102. When more fuel is flowed to engine 101 from fuel tank 102, the rotational speed and power provided to a camshaft of engine 101 increases. When less fuel is flowed to engine 101 from fuel tank 102, the rotational speed and power provided to the camshaft of engine 101 decreases. In this way, control signal S_{Control} and throttle controller 113 control the rotational speed and power the camshaft of engine 101. The signal S_{control} can be of many different types, such as a wired or wireless signal. A wired signal flows through a conductive line and a wireless signal flows wirelessly.

Power unit 100b can provide power to nozzle unit 100a in many ways. In this embodiment, nozzle unit 100a includes a flexible hose 110 that extends between an input port 109 and a nozzle control handle 111. Hose 110 can be of many different lengths, but it is generally chosen to be long enough so that nozzle unit 100a can be used at a desired distance away from power unit 100b. Power unit 100b includes an output port 117 and an output port adapter 107 extending therefrom. Output port adapter 107 is dimensioned to be coupled to and uncoupled from input port 109. In this way, power unit 100b can be coupled to and uncoupled from each other.

A drive cable (not shown) is enclosed in nozzle control handle 111 and flexible hose 110 and extends between input port 109 and a wheel 112. This drive cable can be many different types of material such as a plastic and/or a composite, but here it is steel. The drive cable is dimensioned to fit within an output port adapter 107 and to connect to a camshaft (not shown) within a power unit output port 117 on power unit 100b. Wheel 112 can operate as many different types of wheels, such as a grinding and buffing wheel. Wheel 112 typically includes hard material, such as steel, when used as a grinding wheel. Wheel 112 typically includes a softer material, such as a fibrous cloth, when used as a buffing wheel.

1. The drive cable is connected to the camshaft of engine 101 and rotates in response to the rotation of the camshaft. Hence, when nozzle unit 100a is connected to power unit 100b, the drive cable will rotate in response to the rotation of the camshaft of engine 101. In this way, wheel 112 rotates in response to the camshaft of engine 101 rotating. Hence, the speed of wheel 112 is adjustable in response to adjusting the speed of the camshaft of engine 101. It should be noted that wheel 112 can generally be rotated both clockwise and counterclockwise. For example, in one situation, wheel 112 is rotated clockwise and then switched to counterclockwise rotation. In another situation, wheel 112 is rotated counterclockwise and then switched to clockwise rotation. The switching between clockwise and counterclockwise rotation is important when wheel 112 is being used as a buffing wheel. The rotation of wheel 112 can be controlled in many different ways, such as by controlling the rotation of motor 101. The rotation of motor 101 can be controlled by using a switch included with nozzle unit 100a. In this way, nozzle unit 100a includes a wheel which can be rotated clockwise and counterclockwise in response to the operation of power unit 100b.

In some embodiments, a clutch (not shown) is connected between the camshaft and the drive cable. The clutch is repeatably engageable and disengageable with the drive cable when the camshaft of engine 101 is rotating at high and low rotational speeds, respectively. The clutch engages the drive cable to the camshaft when the camshaft is rotating at a high rotational speed. Further, the clutch disengages the drive cable from the camshaft when the camshaft is rotating at a low rotational speed. It should be noted that, in some embodiments, the rotational speed at which the clutch engages with the drive cable can be set by the operator. In this way, a clutch is used to control the rotational speed of the drive cable.

In some embodiments, cleaning tool 100 includes an air compressor (not shown) which is operated by engine 101. The air compressor provides pneumatic power in the form of compressed air to nozzle unit 100a. The compressed air is pumped through hose 110 to wheel 112, wherein wheel 112 rotates in response to the compressed air. The speed of rotation of wheel 112 is adjustable in response to adjusting the pressure of the compressed air flowed through hose 110. The pressure of the compressed air is adjustable by adjusting the speed of rotation of motor 101. In this way, wheel 112 is provides a desired amount of grinding to clean the structure. It should be noted that wheel 112 is typically rotated, while submerged in water, by an amount sufficient to form an air pocket proximate to it. The air pocket enables nozzle unit 100a to operate under water. It should be noted that compressed air can also be provided to nozzle unit 100a from the exhaust of engine 101. In this embodiment, the exhaust of engine 101 is directed through power unit output port 117. In this way, power unit 100b operates as an air compressor and provides power to nozzle unit 100a. It should be noted that the rotation of the drive cable located inside hose 110 in conjunction with compressed air allows nozzle 100a to function as a quick release system.

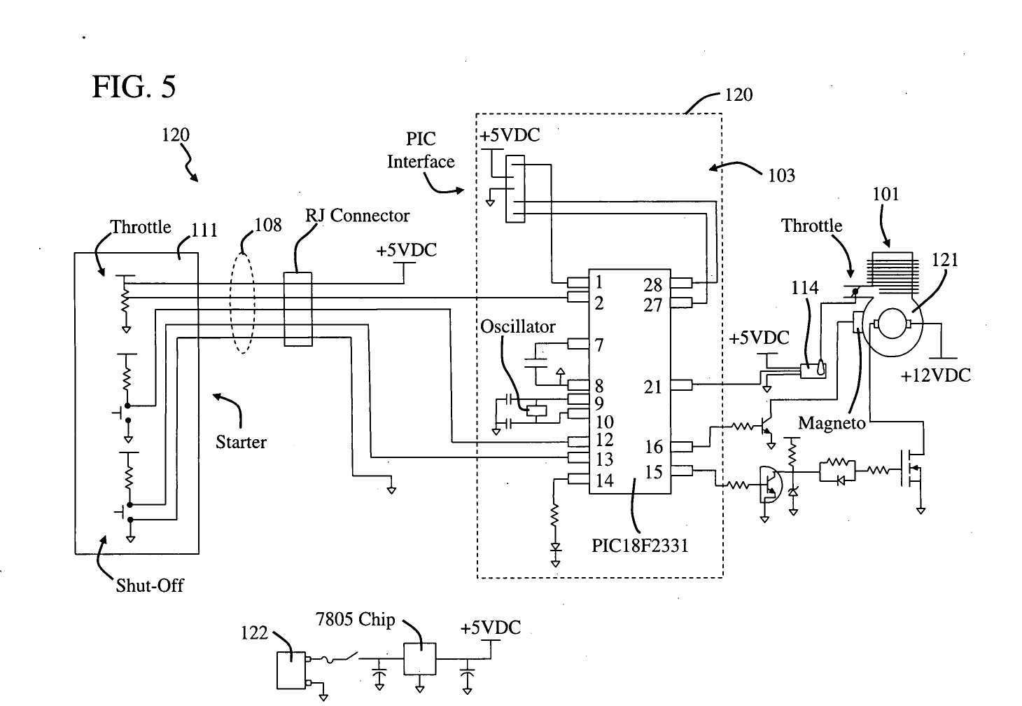

In this embodiment, power unit 100a includes a control circuit 120, as shown in FIG. 5. Control circuit 120 can be positioned at many different locations, but here it is housed within a housing 103 which is carried by support structure 119. Control circuit 120 can include many different types of circuitry. In this embodiment, it includes a microcontroller, such as a 28-pin PIC18F2331 MICROCHIP controller, which allows it to control the operation of engine 101 in response to receiving signal S_{control}. Hence, control circuit 120 also includes circuitry which allows it to transmit and receive signals. Control circuit 120 includes circuitry which allows it to convert information included in the signals it transmits and receives. For example, in some embodiments, control circuit 120 includes an analog-to-digital converter. Hence, signal S_{control} can also be analog and digital and it can be converted therebetween.

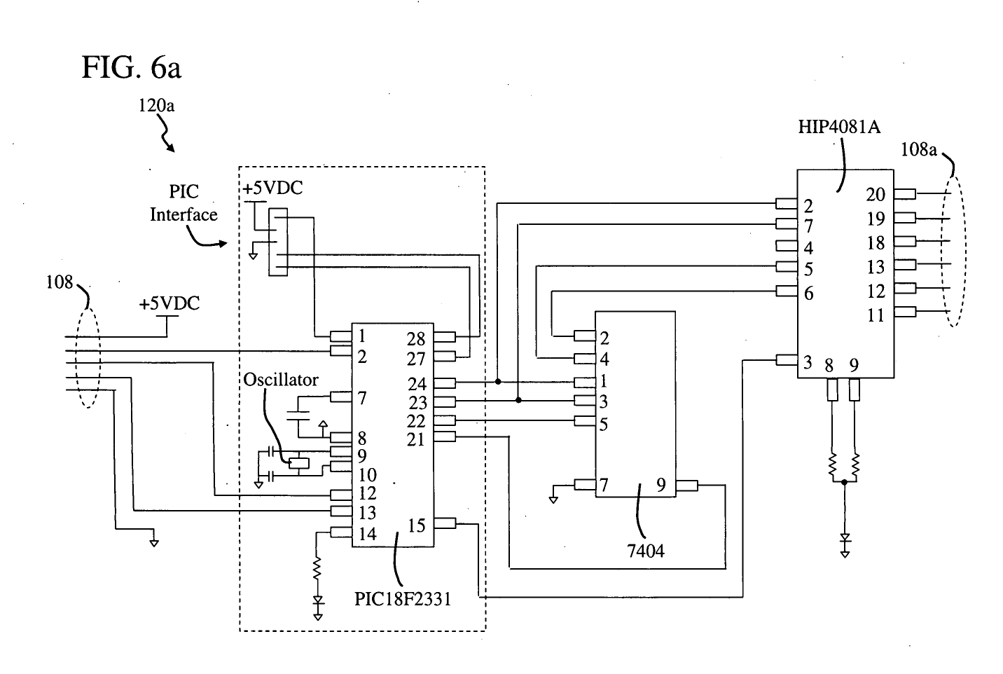

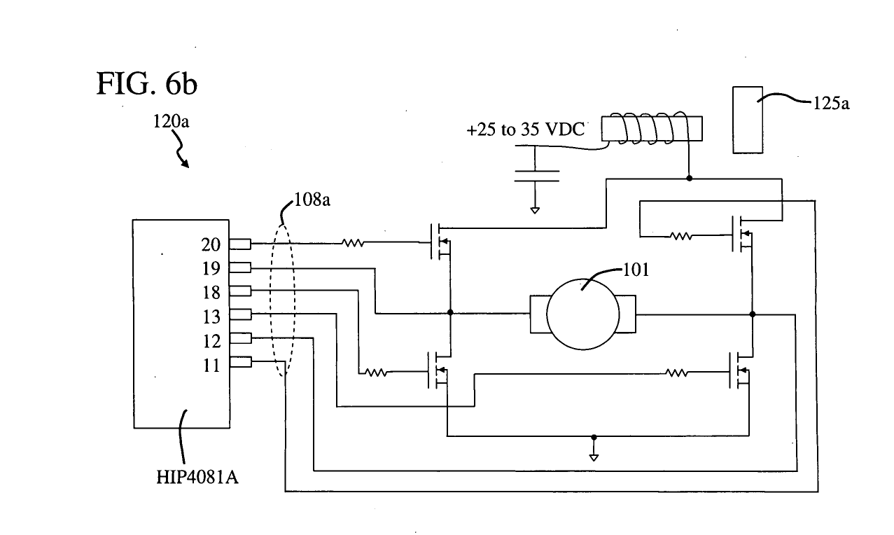

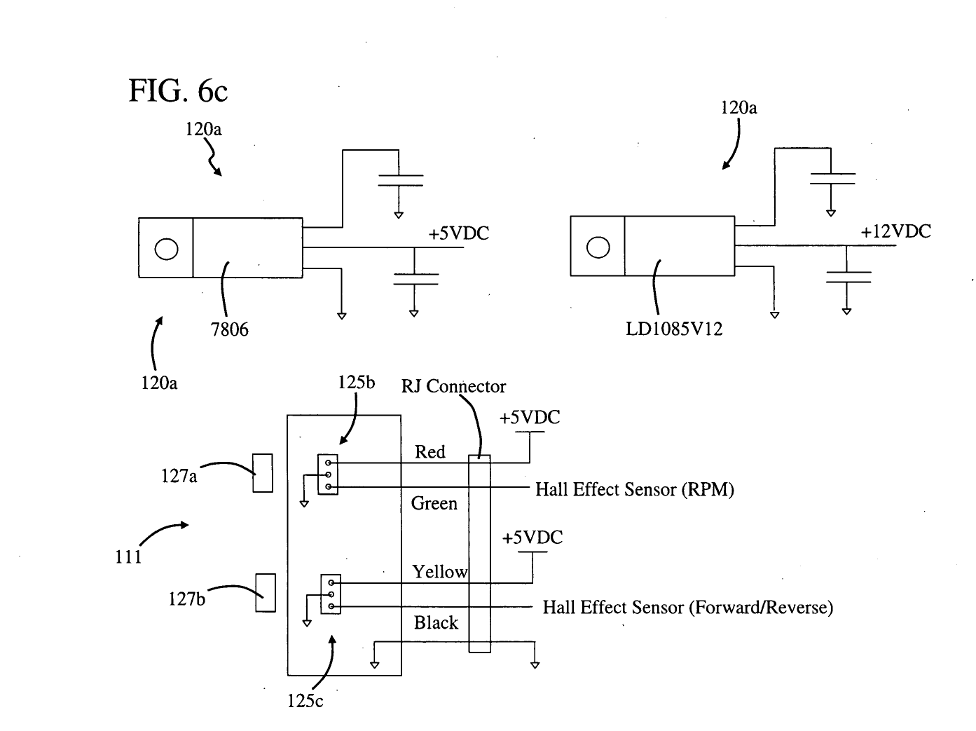

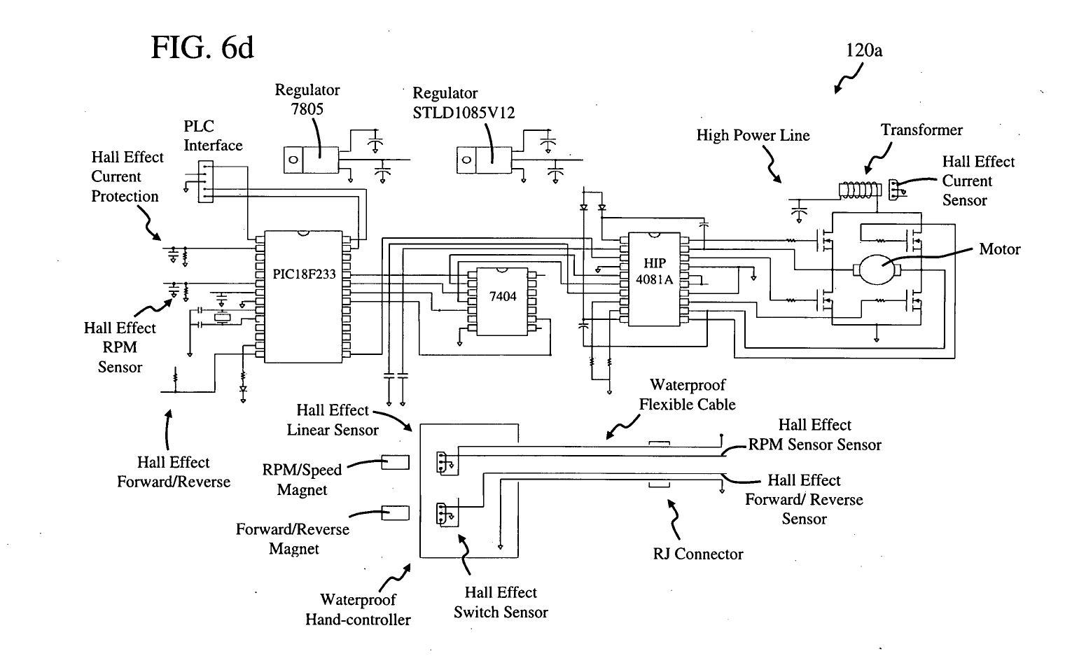

Another embodiment of a control circuit, denoted as control circuit 120a, for a gas engine is shown in a schematic diagram in FIGS. 6a, 6b, 6c and 6d. In this embodiment, control circuit 120a includes the PIC18F2331 MICROCHIP, as well as a 7404 Inverter chip and HIP 4081A H-Bridge High Frequency Driver chip manufactured by Intersil Corporation. More information regarding how these chips are connected in control circuit 120a can be found in their corresponding data sheets. It should be noted that connections 108 of FIG. 6a are connected to circuitry as shown in FIG. 5 and that connections 108a of FIG. 6a are connected to connections 108a of FIG. 6b. The 7806 chip of FIG. 6c is a voltage regulator and the ST LD1086V12 chip is a Low Drop Fixed and Adjustable Positive Voltage Regulator manufactured by STMicroelectronics. Elements 125a, 125b and 125c of FIGS. 6b and 6c are Linear Hall Effect Sensors. Hall effect sensors 125b and 125c are for the RPM sensors and forward and reverse control, respectively. Element 126 in FIG. 6c is the circuitry included in nozzle control handle 111 showing magnets 127a and 127b, which are included with switches 111 and 127, respectively. Hall effect sensor 125a is for turning motor 101 on and off.

Nozzle unit 100a can include many different components which operate, in response to power provided by power unit 100b. In this embodiment, nozzle unit 100a includes a nozzle input port 109 which is repeatably moveable between coupled and uncoupled positions with output port adapter 107. This allows tool 100 to be operator friendly and also provides the option to quickly change the snap-on tool types, easily allowing for use in small confined areas such as the inside water skimmers or using a one-quarter inch cleaning pad to clean between tile grout lines.

Power unit output port 117 flows power from engine 101 outwardly therefrom, through output port adapter 107 and into nozzle unit input port 109. In this way, nozzle unit 100a receives power from power unit 100b. As mentioned above, the power is in the form of compressed air and/or a drive cable. Nozzle unit 100a also has integrated ceramic bearing built into the tool. The integrated ceramic bearing provides a rust-free environment for low maintenance and extended bearing life.

In this embodiment, nozzle input port 109 is connected to a nozzle control handle 111 with a hose 110. Hose 110 can be of many different types, but it is a flexible hose in this embodiment which is capable of flowing compressed air. Control handle 111 operates as a grip which can be grasped by the user using his or her working hand. Nozzle control handle 111 includes a switch 127 to control the operation of power unit 100b and a throttle controller 113 to control the operation of fuel servo 114. In this embodiment, throttle controller 113 and switch 127 are removeably attached to nozzle control handle 111. Throttle controller 113 and switch can be removeably attached to nozzle control handle 111 in many different ways, such as by using a fastener and/or clip. In this way, throttle controller 113 and switch 127 can be removed from one cleaning tool so they can be used with another.

Throttle controller 113 can control the operation of fuel servo 114 in many different ways, such as by flowing signal S_{Control} therebetween. Signal S_{Control} can be flowed between throttle controller 113 and fuel servo 114 in many different ways. For example, it can be flowed through a control cable 108 which extends between nozzle and power units 100a and 100b. It can also be flowed through a wireless link, if desired.

In accordance with the invention, nozzle control handle 111 includes a wireless transceiver (not shown). The wireless transceiver can be of many different types, but here it is a 2.4 GHz wireless transceiver capable of communicating with control circuit 120 of FIG. 5. The wireless receiver enables engine starter 121 and/or engine 101 to respond to a wireless or wired hand held controller. The wired or wireless controller responds by starting engine 101 and switches engine 101 to run in gas or electric mode. Once engine 101 is started, the controller continues responding by operating fuel servo 114 by utilizing one or more sensors included with nozzle control handle 111. These sensors are water submergible so they can operate when exposed to water or submerged therein. These water submergible sensors are also removeable from and interchangeable with different cleaning tools. As discussed in more detail below, the water submergible sensors are controlled by the user and enable an increase or decrease in engine output power. As the engine output power increases, the air pressure and/or engine speed increases. Further, as the engine output power decreases, the air pressure and/or engine speed decreases.

In accordance with the invention, nozzle control handle 111 includes one or more sensors. In this embodiment, the sensors include two Hall Effect sensors, which determine the magnitude of a changing magnetic field. One Hall Effect sensor is used for throttle control and the other Hall Effect sensor is used to turn engine 101 on and off. The Hall Effect sensors are hermetically sealed and provide an electrical signal in response to a changing magnetic field.

In this embodiment, the changing magnetic field for throttle control is provided in response to moving a throttle magnet. The throttle magnet is housed within a throttle controller 113. In this way, the changing throttle magnet operates as an engine throttle. In operation, the user moves the throttle magnet with his or her working hand. As the throttle magnet moves relative to the Hall Effect sensor, the Hall Effect sensor and throttle controller 113 provide a linear electrical signal to control circuit 120 in proportion to the position of the throttle magnet. Control circuit 120 converts the analog signal into a digital signal, which is then used to control a fuel servo connected to fuel servo 114 and DC Motor 201. Fuel servo 114 is operatively coupled to engine 101 and carburetor 114 so it controls the speed of operation of engine 101, as discussed above. In this way, the speed of operation of engine 101 is controlled with nozzle control handle 111.

Nozzle control handle 111 includes an ON/OFF switch 127 which includes an ON/OFF magnet (not shown). The ON/OFF magnet is magnetically coupled with one Hall Effect sensor and the throttle magnet is magnetically coupled with the other Hall Effect sensor.

Signal S_{Control} can include both the throttle information and the ON/OFF information. For example, a first portion of the signal corresponds to a desire to move engine 100 to its OFF condition. A second portion of the signal corresponds to a desire to move engine 100 to its ON condition. A third portion of signal S_{Control} corresponds to a desire to operate engine 101 at a desired speed of operation so that it outputs a desired amount of air pressure through output port 117.

The other Hall Effect sensor determines the amount the ON/OFF magnetic is moved by determining its change in magnetic field to provide ON/OFF information. The other Hall Effect sensor on the DC Power Unit determines the amount the rotation magnetic is moved by determining its change in magnetic field to provide direction of rotation information. The information is flowed to the microprocessor, as described above, and the microprocessor processes it to control the state of operation of engines 101 and 201. In one state of operation, engine 101 is ON and in another state of operation, engine 101 is OFF. In one state of operation, engine 201 is rotated clockwise and, in another state of operation, engine 201 is rotate counterclockwise. The direction of rotation of wheel 112 depends on the rotation direction of engine 100. In one embodiment, wheel 112 rotates clockwise and counterclockwise in response to engine 100 rotating clockwise and counterclockwise, respectively.

In one embodiment, when it is desired to shut off engine 101, the first portion of the throttle movement information corresponds to a low signal. When it is desired to turn on engine 101, the third portion of the throttle movement information corresponds to a high signal.

On the hand held controller, the information is sent to a microprocessor, which is then sent to the transceiver. The transceiver converts the digital information into RF signal which is sent to the gas engine unit. At the gas engine unit, the transceiver receives the RF signal then converts it into digital information for the microprocessor to control the gas engine for throttle control, gas engine shut off, gas engine enable, and gas engine starter.

In operation, the amount of power provided by engine 101 is controlled by controlling the amount of fuel flowed between fuel tank 102 and carburetor 115. The amount of fuel flowed between fuel tank 102 and carburetor 115 is controlled by controlling fuel servo 114. Fuel servo 114 is generally controlled with carrying hand 100. Fuel servo 114 can be controlled with carrying hand 100 when support structure 100 is supported by the support surface or when it is carried by the user.

The amount of power provided by engine 101 and 210 is adjusted by adjusting throttle controller 127, as discussed above. Control signal S_{Control} is adjusted by adjusting throttle controller 127. This allows for safe and efficient one-handed operation. Being able to control the speed of operation of motor 101 with one hand is useful because it can be done while looking at the working surface. This reduces the likelihood of damaging the working surface while cleaning it.

The user's wireless or wired controller controls the torque of the drive cable or drive shaft by changing the position of the controller switch. The operator decides which hand held tool to select such as a buffer, die grinder, grinder, polishing wheel, orbital sander (FIG. 7) and cutting wheel. The tool is locked into position by aligning the drive cable into the hand held tool and sliding the coupling into a quick release button. The operator then clips on the removable wireless or wired controller locking it on to the appropriate tool enabling the operator to control the tool at the operator hand while submerged under water.

While particular embodiments of the invention have been shown and described, numerous variations and alternate embodiments will occur to those skilled in the art. Accordingly, it is intended that the invention be limited only in terms of the appended claims.

1. A cleaning tool, comprising:
a power unit which includes a gas powered engine with a carburetor and fuel servo;
a nozzle unit operatively coupled with the power unit, the nozzle unit including a throttle controller; and
a control circuit which adjusts the amount of fuel flowing through the carburetor in response to a signal provided in response to adjusting the throttle controller.

2. The tool of claim 1, wherein the control circuit includes a microcontroller in communication with the throttle controller and fuel servo.

3. The tool of claim 1, wherein the nozzle unit operates in response to mechanical energy provided by the power unit.

4. The tool of claim 1, wherein the nozzle unit includes a first switch for controlling the operation of the fuel servo to of the power unit.

5. The tool of claim 1, wherein the control circuit is in wireless communication with the nozzle unit.

6. The tool of claim 1, wherein the nozzle unit and power unit are hermetically sealed.

7. The tool of claim 1, wherein the nozzle control handle includes a wireless transceiver.

8. A cleaning tool, comprising:
a power unit which includes a gas powered engine with a carburetor and fuel servo;
a nozzle unit operatively coupled with the power unit, the nozzle unit including a throttle controller; and
a control circuit which adjusts the amount of fuel flowing through the carburetor in response to a wireless signal provided in response to adjusting the throttle controller.

9. The tool of claim 8, wherein the control circuit includes a microcontroller in communication with the throttle controller and fuel servo, the microcontroller being hermetically sealed within a housing of the power unit.

10. The tool of claim 8, wherein the nozzle unit operates in response to compressed air provided by the power unit.

11. The tool of claim 8, wherein the nozzle unit includes a sensor switch for controlling the operation of the fuel servo and an ON/OFF Hall sensor switch for the power unit.

12. The tool of claim 11, wherein the first and second switches are positioned to be operable with a working hand of the user.

13. The tool of claim 11, wherein the first and second switches are positioned to be operable with a working hand of the user while simultaneously carrying the power unit with a carrying hand.

14. A cleaning tool, comprising:
a power unit which includes a battery operated engine engine;
a nozzle unit operatively coupled with the power unit, the nozzle unit including a throttle controller; and
a control circuit which adjusts the amount of fuel flowing through the carburetor in response to a wireless signal provided in response to adjusting the throttle controller.

15. The tool of claim 14, wherein the control circuit includes a microcontroller in communication with the throttle controller, the microcontroller being hermetically sealed within a housing of the power unit.

16. The tool of claim 14, wherein the nozzle unit includes a sensor switch for controlling the operation of the fuel servo and an ON/OFF Hall sensor switch for the power unit.

17. The tool of claim 18, wherein the first and second switches are positioned to be operable with a working hand of the user while simultaneously carrying the power unit with a carrying hand.

18. The tool of claim 14, wherein the power unit includes a battery for powering the motor, the battery being chargeable in response to receiving an electromagnetic signal.

19. The tool of claim 14, wherein the nozzle unit includes a wheel which can be rotated clockwise and counterclockwise in response to the operation of the power unit.
